(19) United States
(12) Patent Application Publication
(10) Pub. No.: US 2017/0142662 A1
(43) Pub. Date: May 18, 2017

(54) METHODS FOR CONTROLLING UPLINK TRANSMIT POWER IN A WIRELESS NETWORK

(71) Applicants: Ilan Sutskover, Hadera (IL); Laurent Cariou, Portland, OR (US)

(72) Inventors: Ilan Sutskover, Hadera (IL); Laurent Cariou, Portland, OR (US)

(21) Appl. No.: 15/086,460

(22) Filed: Mar. 31, 2016

Related U.S. Application Data
(60) Provisional application No. 62/256,242, filed on Nov. 17, 2015.

(51) Int. Cl. H04W 52/14; H04L 1/00; H04W 72/04

(52) U.S. Cl. CPC H04W 52/146; H04W 72/042; H04L 1/0003; H04L 1/0009

(57) ABSTRACT

Methods, apparatuses, computer readable media to control uplink transmit power in a wireless network. An apparatus of a wireless device comprising processing circuitry is disclosed. The processing circuitry is configured to determine MCSs to assign to stations based on an estimated transmission power the stations are to use to transmit using the corresponding MCS of the MCSs, and based on a receive range of the wireless device. The processing circuitry is further configured to encode a trigger frame comprising an uplink resource allocation for the stations and an indication of the corresponding MCS of the MCSs for each of the stations to use for the uplink resource allocation. The trigger frame may include a transmit power information request. The processing circuitry is further configured to decode packets encoded with the corresponding MCS of the MCSs, and each packet comprises a transmit power the corresponding station would use for a different MCS.

### PRIORITY CLAIM

This application claims the benefit of priority under 35 USC 119(e) to U.S. Provisional Patent Application Ser. No. 62/256,242, filed Nov. 17, 2015, which is incorporated herein by reference in its entirety.

### TECHNICAL FIELD

Embodiments relate to Institute of Electrical and Electronic Engineers (IEEE) 802.11. Some embodiments relate to high-efficiency wireless local-area networks (HEWs). Some embodiments relate to IEEE 802.11ax. Some embodiments relate computer readable media, methods, and apparatuses to control uplink (UL) transmit power in a wireless network. Some embodiments relate to wireless local area network (WLAN).

### BACKGROUND

Efficient use of the resources of a wireless local-area network (WLAN) is important to provide bandwidth and acceptable response times to the users of the WLAN. However, often there are many devices trying to share the same resources and the devices may interfere with one another. Additionally, the wireless devices may be moving and the signal quality may be changing. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments;

FIG. 2 illustrates a method for controlling UL transmit power in a wireless network;

FIG. 3 illustrates a HE station configured to determine an estimated transmit power (TXP) based on a modulation and coding scheme (MCS);

FIG. 4 illustrates a method for controlling uplink transmit power in a WLAN in accordance with some embodiments;

FIG. 5 illustrates a method for controlling uplink transmit power in a WLAN in accordance with some embodiments; and

FIG. 6 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

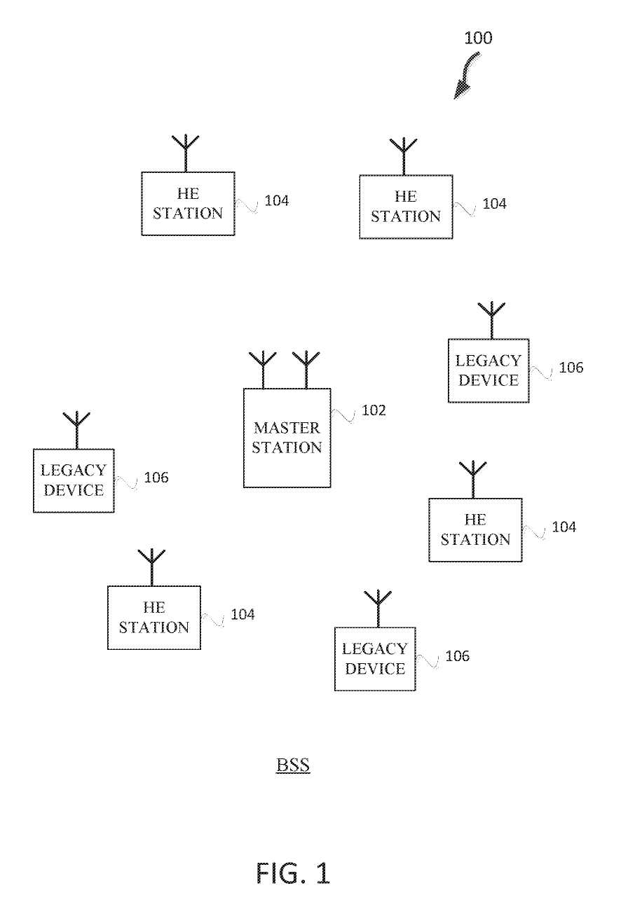

FIG. 1 illustrates a WLAN 100 in accordance with some embodiments. The WLAN may comprise a basis service set (BSS) 100 that may include a master station 102, which may be an AP, a plurality of high-efficiency wireless (e.g., IEEE 802.11ax) (HE) stations 104, and a plurality of legacy (e.g., IEEE 802.11n/ac) devices 106.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one master station 102 that is part of a extended service set (ESS). A controller may store information that is common to the more than one master stations 102.

The legacy devices 106 may operate in accordance with one or more of IEEE 802.11a/b/g/n/ac/ad/af/ah/aj/ay, or another legacy wireless communication standard. The legacy devices 106 may be STAs or IEEE STAs. The HE STAs 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HE STAs 104 may be termed high efficiency (HE) stations.

The master station 102 may communicate with legacy devices 106 in accordance with legacy IEEE 802.11 communication techniques. In example embodiments, the master station 102 may also be configured to communicate with HE STAs 104 in accordance with legacy IEEE 802.11 communication techniques.

In some embodiments, a HE frame may be configurable to have the same bandwidth as a channel. The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, or 242 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones for a 242 point Fast Fourier Transform (FTT).

A HE frame may be configured for transmitting a number of spatial streams, which may be in accordance with MU-MIMO and may be in accordance with OFDMA. In other embodiments, the master station 102, HE STA 104, and/or legacy device 106 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE communications. In accordance with some IEEE 802.11ax embodiments, a master station 102 may operate as a master station which may be arranged to contend for a wireless medium (e.g., during a contention period) to receive exclusive control of the medium for an HE control period. In some embodiments, the HE control period may be termed a transmission opportunity (TXOP). The master station 102 may transmit a HE master-sync transmission, which may be a trigger frame or HE control and schedule transmission, at the beginning of the HE control period. The master station 102 may transmit a time duration of the TXOP and sub-channel information. During the HE control period, HE STAs 104 may communicate with the master station 102 in accordance with a non-contention based multiple access technique such as OFDMA or MU-MIMO. This is unlike conventional WLAN communications in which devices communicate in accordance with a contention-based communication technique, rather than a multiple access technique. During the HE control period, the master station 102 may communicate with HE stations 104 using one or more HE frames. During the HE control period, the HE STAs 104 may operate on a sub-channel smaller than the operating range of the master station 102. During the HE control period, legacy stations refrain from communicating. The legacy stations may need to receive the communication from the master station 102 to abstain from communicating.

In accordance with some embodiments, during the master-sync transmission the HE STAs 104 may contend for the wireless medium with the legacy devices 106 being excluded from contending for the wireless medium during the master-sync transmission. In some embodiments the trigger frame may indicate an uplink (UL) UL-MU-MIMO and/or UL OFDMA control period.

In some embodiments, the multiple-access technique used during the HE control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 and/or HE stations 104 in accordance with legacy IEEE 802.11 communication techniques. In some embodiments, the master station 102 may also be configurable to communicate with HE stations 104 outside the HE control period in accordance with legacy IEEE 802.11 communication techniques, although this is not a requirement.

In some embodiments the HE station 104 may be a “group owner” (GO) for peer-to-peer modes of operation. A wireless device may be HE station 102 or a master station 102.

In example embodiments, the HE device 104 and/or the master station 102 are configured to perform the methods and functions herein described in conjunction with FIGS. 1-6.

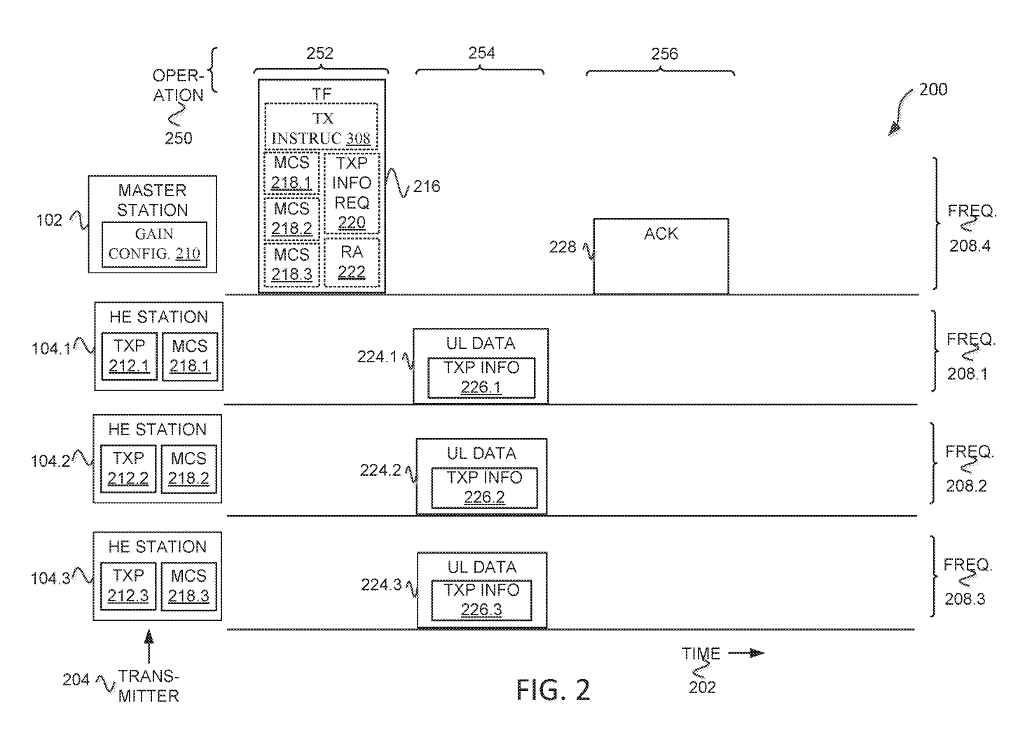

FIG. 2 illustrates a method for controlling UL transmit power in a wireless network. Illustrated in FIG. 2 is time 202 along a horizontal axis, frequency 208 along a vertical axis, transmitter 204, and operations 250 along the top. The transmitter 204 may be a master station 102 or a HE station 104. The frequency 208 may be channels, e.g. less than 20 MHz, 20 MHz, 40 MHz, 80 MHz, 160 MHz, 320 MHz, or another bandwidth. The frequencies 208 may overlap. For example, two HE stations 104 may be allocated the same frequencies 208 for MU-MIMO.

The master station 102 may include a gain configuration 210. The gain configuration 234 may determine a range of signal strengths that the master station 102 can receive simultaneously from the HE stations 104 transmitting at TXP 212.

The HE station 104 may use a transmit power (TXP) 212 and modulation and coding scheme (MCS) 218 to transmit UL data 224. The TXP 212 indicates the TXP used to transmit UL data 224 and the MCS 218 indicates the MCS used to encode the UL data 224. For example, the HE station 104 may include an encoder that can be configured to use the MCS 218 as a target MCS, and the HE station 104 may have a transmit (TX) gain control that can be configured with the TXP 212 as a target TXP. The MCS 218 may be the MCS 218 received from the master station 102.

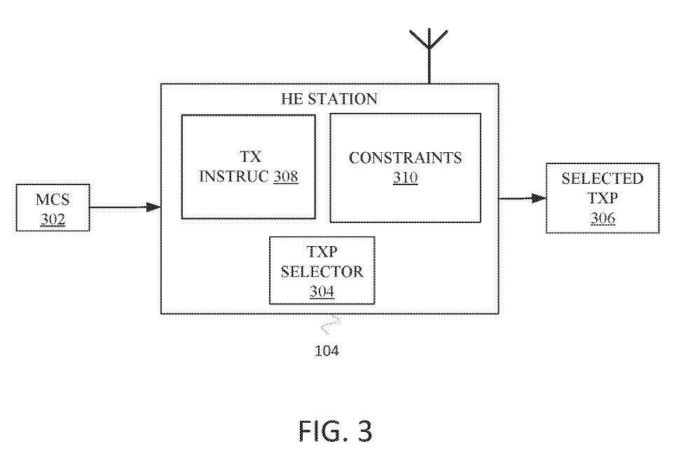

The method 200 may begin at operation 252 with the master station 102 transmitting a trigger frame (TF) 216 to the HE stations 104.1, 104.2, and 104.3. The TF 216 may comprise MCSs 218, TXP instructions 308 (described in conjunction with FIG. 3), TXP information request 220, and resource allocation 222. The resource allocation 222 may indicate a frequency 208 for the HE station 104 to transmit on. The resource allocation 222 may include other air resources as well. In some embodiments, the TF 216 may include TX instructions 308 as disclosed in conjunction with FIG. 3.

TXP information request 220 may be a request for the HE stations 104 to indicate a power the HE station 104 would use for a MCS. The TXP information request 220 may be relative to the power the HE station 104 would use to transmit using the MCS 218. In some embodiments, the TF 216 does not include the TXP information request 220. In some embodiments, the HE station 104 may generate TXP information 226 without the TXP information request 220. In some embodiments, HE station 104 may generate TXP information 226 based on a predetermined arrangement with the master station 102 that the TX information 226 should be sent and what the TXP information 226 should include. In some embodiments, the TXP information 226 may be information in accordance with one or more wireless communication specifications such as IEEE 802.11.

The TXP information request 220 may indicate a request for the information of the TXP information 226. In the following MCS refers to the MCS 218, which may be termed the current MCS. The TXP information 226 may be one or more of the following: estimated transmit power for MCS 218, estimated transmit power for +1 MCS; estimated transmit power for −1 MCS; estimated transmit power for +1 MCS and −MCS; estimated transmit power for an indicated MCS; estimated transmit power for +2, +1, −1, and −2 MCS; estimated transmit power for +3, +2, +1, −1, −2, and −3 MCS; estimated transmit power for X higher MCS, e.g., MCS +2 for X=2; estimated transmit power for X higher and lower MCS; or, estimated transmit power for X lower MCS. The reported transmit power may be one or more of the following: a differential power from a reference power, a differential power from a predetermined target power for a selected MCS, a differential power from a predetermined target power for a selected MCS with an instantaneous limitation, an absolute power, and an indication of the estimated transmit power. The term MCSx where x is an integer refers to MCSs defined in a communication standard such as IEEE 802.11. In some embodiments, the MCS may be represented differently. For example, the MCS may specify a particular type of MCS such as quadrature amplitude modulation (QAM) 256 with a coding rate of ½.

The MCSs 218 may indicate MCSs the corresponding HE station 104 is to use to encode the UL data 224. For example, MCS 218.1 may indicate a MCS for HE station 104.1 to encode UL data 224.

The master station 102 may determine the MCSs 218 so that its dynamic range is enough to receive all the signals from the UL data 224. The dynamic range may be determined by its chain performance. The master station 102 may determine the MCSs 218 so that the same gain configuration can be used at the master station 102 to receive the signals from the UL data 224. For example, if two HE stations 104 transmit, one at a higher MCS 218 and another at lower MCS 218, then they should be received by the master station 102 with a power difference that is more or less their signal-to-noise ratio (SNR) difference. If the power difference is much larger than the SNR difference, then the master station's 102 automatic gain control (AGC) may tune to the strongest signal and the weaker signal will not be received properly. The master station 102 may determine the MCSs 218 so that the UL data 224 arrive at the master station 102 with the correct power so that all the signals form the UL data 224 can be decoded. The TXP 212 of the HE station 104 depends on the MCS 218.

The method 200 may continue at operation 254 with the HE station 104 transmitting the UL data 224 in accordance with the TXP 212, MCS 218, and RA 222. The MCS 218 may be the MCS 218 indicated in the TF 216. The TXP 212 may be a power that is indicated by the master station 102. For example, the master station 102 may include a TXP for the HE station 104 to use for the MCS 218 in the TF 216. In some embodiments, the TXP 212 is determined by the HE station 104 based on the MCS 218, e.g., as disclosed in conjunction with FIG. 3. The HE station 104 may be configured to encode TXT information 226 response in response to TXT information request 220. For example, TXP selector 304 (FIG. 3) may determine TXP information 226 response to TXP information request 220 as described in conjunction with FIG. 3.

The method 200 may continue at operation 256 with the master station 102 transmitting an acknowledgment (ACK) 228 to the HE stations 104 to acknowledge receipt of the UL data 224. In some embodiments, the ACK 228 may be a block ACK (BACK). In some embodiments, the ACK 228 may be a multi-user block acknowledgement (M-BA), which may be a broadcast frame and may include multiple ACKs or BACKs for multiple users. The master station 102 may ACK the UL data 224 in a different way. For example, in one embodiment, the master station 102 transmit a separate ACK to each of the HE stations 104 on their corresponding frequency 208. In another embodiment, the master station 102 may send another frame such as another TF that implicitly ACKs the UL data 224. The method 200 may end or continue with one or more additional operations 250.

FIG. 3 illustrates a HE station 104 configured to determine a selected transmit power (TXP) based on a modulation and coding scheme (MCS). Illustrated in FIG. 3 is HE station 104, MCS 302, and selected TXP 306. The HE station 104 may include a TXP selector 304, TX instructions 308, and constraints 310. The TXP selector 304 may be configured to determine or select a selected TXP 306 for a given MCS 302. The TXP selector 304 may be integrated into the operation of the HE station 104. The TXP selector 304 may be used to determine or select TXP 212. For example, the selected TXP 306 for MCS 218 may be used as the TXP 212 for UL data 224. The TXP selector 304 may be configured to respond to TXP information requests 220 from a master station 102 by generating one or more selected TXP 306 for one or more MCSs 302. The MCS 302 may be received from the master station 102 for the HE station 104 to use to transmit a packet.

The TX instructions 308 may be master station parameters/FB. The TX instructions 308 may include a signal path-loss through a link margin parameter where the signal path loss is between the HE station 104 and the master station 102. In some embodiments, the TX instructions 308 or a portion of the TX instructions 308 is included in the TF 216 (FIG. 2). The TX instructions 308 may include a target received signal strength in (RSSI) from the HE station 104 to the master station 102. The TX instructions 308 may include a predetermined SNR. The TX instructions 308 may be included with the TF 216 or another frame from the master station 102. In some embodiments the TX instructions 308 may include a TXP for the HE station 104 to use for a given MCS (e.g., 17 dBm for MCS6).

The constraints 310 may include signal quality or error thresholds for error vector magnitude (EVM). The constraints 310 may include specific absorption rate (SAR) limits. The constraints 310 may include coexistent wireless communication standard selected TXP 306 limits. The constraints 310 may include station dependent restrictions (e.g., regulatory limits of a maximum selected TXP 306 of 15 dBm.) The constraints 310 may include one or more rules that are configured by the manufacturer. For example, the HE station 104 may be configured to reduce selected TXP 306 if a battery power is low. The HE station 104 may be configured to reduce selected TXP 306 if a device that includes the HE station 104 is also communicating using BlueTooth®.

The TXP selector selects the TXP 212 based at least on the MCS 302. The TXP selector 304 may select the selected TXP 306 based on how the selected TXP 306 affects to EVM. For example, the HE station 104 may maintain errors of the EVM below thresholds. The thresholds may be based on one or more communication specifications such as IEEE 802.11. Higher MCS 302 may require a lower selected TXP 306 in order to ensure the signal quality is in compliance with EVM thresholds. If the selected TXP 306 is lower, which may be due to small path loss between the HE station 104 and the master station 102, then the selected TXP 306 and MCS 302 may not be as dependent on one another. In some embodiments, the selected TXP 306 may not depend on the EVM.

In some embodiments, the HE station 104 may be required to transmit the UL data (e.g., UL data 224) with the MCS 302. The HE station 104 may determine the selected TXP 306 according to some parameters provided by the master station 102. For example, the signal path-loss or a target RSSI from the HE station 104 to the master station 102.

In some embodiments, the selected TXP 306 of the HE station 104 may be limited based on regulatory requirements. In some embodiments, the selected TXP 306 of the HE station 104 may be limited based on an instantaneous limit (e.g. SAR or a coexistent wireless communication standard.) In some embodiments, the HE station 104 may be configured to minimize interference with co-existence standards. For example, if the HE station 104 is using BlueTooth®, then the HE station 104 may be configured to use a lower selected TXP 306 to reduce interference with BlueTooth® communications. In some embodiments, the master station 102 may request the HE station 104 not to use a selected TXP 306 higher than is needed to communicate with the master station 102 within a predetermined SNR.

In some embodiments, the TXP selector 304 selects a selected TXP 306 based on a required selected TXP 306 (e.g. 12 dBm) from the master station 102. In some embodiments, the TXP selector 304 may select a selected TXP 306 based on one or more of the following: a standard or regulation (e.g., EVM, mask, spectral density maximum power, total maximum power, etc.), HE station 104 configuration (e.g., lowering selected TXP 306 to save power, lower selected TXP 306 to lower interference with a coexistent communication protocol such as BlueTooth®), and instructions from the master station 102 regarding power control.

The HE station 104 may respond to TXP information requests (e.g., 220). For example, the HE station 104 may indicate to the master station 102 that the UL data 224 was transmitted at 12 dBm with a MCS 302 of MCS6. The HE station 104 may respond to a TXP information request (e.g., 220) with, e.g., an indication of the selected TXP 306 the TXP selector 304 would select for MCS5 and MCS7. The following are examples of TXP information (e.g., 226) that the HE station 104 may send to the master station 102 in response to a TXP information request (e.g., 220.) For example, if the current MCS 302 is MCS6, then the HE station 104 may respond to a TXP information request (e.g., 220) with a TXP information including MCS6 at 12 dBm, MCS5 at 17 dBm, and MCS7 at 15 dBm.

In some embodiments, the HE station 104 may have used 12 dBm for MCS6 because the master station 102 instructed the HE station 104 to use that TXP. In some embodiments, MCS6 at 12 dBm means that the HE station 104 would select a selected TXP 306 of 12 dBm to transmit a packet at MCS6 under the current conditions. The HE station 104 may determine the selected TXP 306 the HE station 104 would use for different MCSs 302 based on the TXP selector 304.

In some embodiments, the master station 102 may interpret the TXP information (e.g., 226) response. For example, in the example above the master station 102 may interpret the TXP information (e.g., 226) to determine that MCS6 is at 12 dBm now, but may be increased to between 15 dBm and 17 dBm. In some embodiments, differential TXP may be indicated in the TXP information (e.g., 226).

The HE station 104 may send the following TXP information (e.g., 226) response in response to the TXP information request (e.g., 220). MCS6 at 0 dB, MCS5 at +5 dB, and MCS7 at +3 dB, where 0 dB may mean that the HE station 104 uses a selected TXP 306 that is required by the master station 102.

In some embodiments, the TXP selector 304 may determine the selected TXP 306 based on station dependent restrictions. For example, regulatory limits of 15 dBm for a maximum selected TXP 306. For example, for a MCS 302 of MCS6 requested by the master station 102, the response from the HE station 104 may be MCS6 at 12 dBm, MCS5 at 15 dBm, and MCS7 at 15 dBm, where the selected TXP 306 may be determined based on the maximum selected TXP 306 of 15 dBm.

In some embodiments, the master station 102 may request a TXP too high for the HE station 104, for example a TXP greater than a 15.5 dBm regulatory limitation. For example, the master station 102 may request that the HE station 104 transmit a packet with MCS 302 of MCS6 and a selected TXP 306 of 16 dBm. The HE station 104 may have a 15.5 dBm maximum TXP regulatory limitation. In this case, the TXP selector 304 may determine the selected TXP 306 for MCS5, MCS6, and MCS7 based on capping the TXP of MCS5, MCS6, and MCS 7 at the maximum TXP regulatory limit. The HE station 104 may respond to the TXP information request 220 with MCS6 at 15.5 dBm, MCS5 at 15.5 dBm, and MCS7 at 15 dBm.

In some embodiments, the HE station 104 may have instantaneous limitations such as in-device coexistence requirements, e.g., a Long-Term Evolution (LTE) device may limits the selected TXP 306 to a maximum of 5 dBm through an intra-platform coexistence mechanism. The TXP selector 304 may then limit the selected TXP 306 for a given MCS 302 based on the instantaneous limitations (e.g., 5 dBm).

In some embodiments, assuming that the instantaneous limitations (e.g., 5 dBm) are in place for a current packet and a next packet, then the HE station 104 may respond to the TXP information request 220 with TXP information 226 response of MCS6 at 5 dBm, MCS5 at 5 dBm, and MCS7 at 5 dBm.

In some embodiments, if the instantaneous limitation is only relevant for current a packet (e.g., UL data 224), then the HE station 104 may respond to the TXP information request 220 with a TXP information 226 response of MCS6 at 5 dBm, MCS5 at 17 dBm, and MCS7 at 11.5 dBm. The TXP selector 304 may refrain from capping the selected TXP 306 for a given MCS 302 if the instantaneous limitation (or any limitation) will not apply for a next packet.

In some embodiments, e.g., coexistence, a next packet is not likely to suffer from same limitation, while in other cases (proximity detection) a next packet is likely to suffer from same limitation. The TXP selector 304 may be configured to estimate the selected TXP 306 based on whether it is likely that a limitation or restriction is likely to occur for a next packet. The HE station 104 may send the TXP information 226 response based on the TXP selector 304 estimation based on the likelihood of a limitation or restriction being in place for a next packet.

In some embodiments, the master station 102 may transmit a TXP information request 220 for a specific MCS 302. For example, TXP information request 220 may indicate MCS0, when the MCS 218 (FIG. 2) is indicated as MCS6. The TXP selector 304 may determine the selected TXP 306 for the requested MCS 302, e.g. continuing the example MCS0. The HE station 104 may respond with a TXP information 226 response of selected TXP 306 for MCS0, which may be indicated by an absolute TXP or a differential TXP.

In some embodiments TXP information 226 (FIG. 2) requires less signaling than the HE stations 104 signaling an entire set of TXP 212 capabilities for MCSs 218. The master station 102 may be able to make determinations of MCSs 218 for the HE stations 104 to use based on the TXP information 226 responses rather than larger responses with information regarding more MCSs. The selected TXP 306 (FIG. 3) for MCSs 302 may change with time, sometimes slowly (e.g., reacting to thermal aspects) and sometimes abruptly (e.g., reacting to proximity detectors or to coexistence needs with other devices on the same platform.)

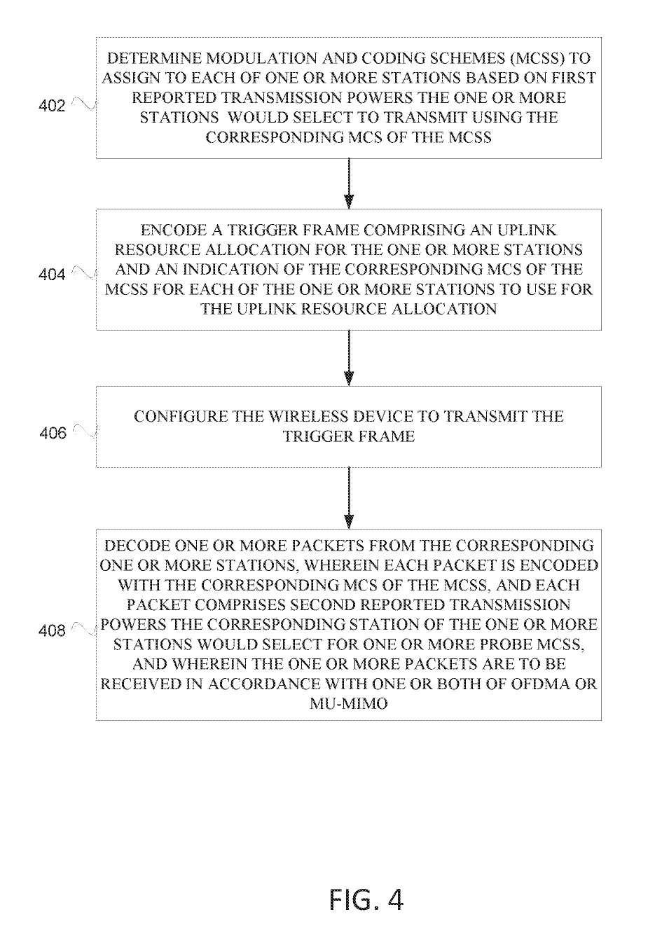

FIG. 4 illustrates a method 400 for controlling uplink transmit power in a WLAN in accordance with some embodiments. The method 400 may begin with operation 402 with determining modulation and coding schemes (MCSs) to assign to each of one or more stations based on first reported transmission powers the one or more stations would select to transmit using the corresponding MCS of the MCSs. For example, the master station 102 (FIG. 2) may determine MCS 218 based on previously received TXP information 226. In some embodiments, the MCSs of the TXP information 226 may be different than the MCS 218 so that the master station 102 may not have received information for an MCS 218 the master station 102 assigns to a HE station 104. The master station 102 may determine the MCSs 218 based MCSs received in TXP information 226, but that do not include information for each of the MCSs 218.

The method 400 continues at operation 404 with encoding a trigger frame comprising an uplink resource allocation for the one or more stations and an indication of the corresponding MCS of the MCSs for each of the one or more stations to use for the uplink resource allocation. For example, master station 102 may encode TF 216. In some embodiments, the MCSs 218 may not correspond to MCSs reported in the TXP information 226.

The method 400 may continue at operation 406 with configuring the wireless device to transmit the trigger frame. For example, an apparatus of the master station 102 may configure the master station 102 to transmit TF 216. The apparatus may be a portion of the machine 600.

The method 400 may continue at operation 408 with decoding one or more packets from the corresponding one or more stations, where each packet is encoded with the corresponding MCS of the MCSs, and each packet comprises second reported transmission powers the corresponding station of the one or more stations would select for one or more probe MCSs. For example, the master station 102 may decode UL data 224 with TXP information 226. The UL data 224 may have been transmitted in accordance with the TF 216 and the corresponding MCS 218. The TXP information 226 may include information regarding a TXP the HE station would select for a given MCS. The probe MCSs may be indicated in the TF 216, or the HE station 104 may be configured to select the MCSs based on one or more of the following: a communication standard, a prior agreement with the master station 102, and/or a configuration of the HE station 104 for selecting the probe MCSs. In some embodiments the UL data is received in accordance with one or both of OFDMA or MU-MIMO. The method 400 may end or continue with additional operations.

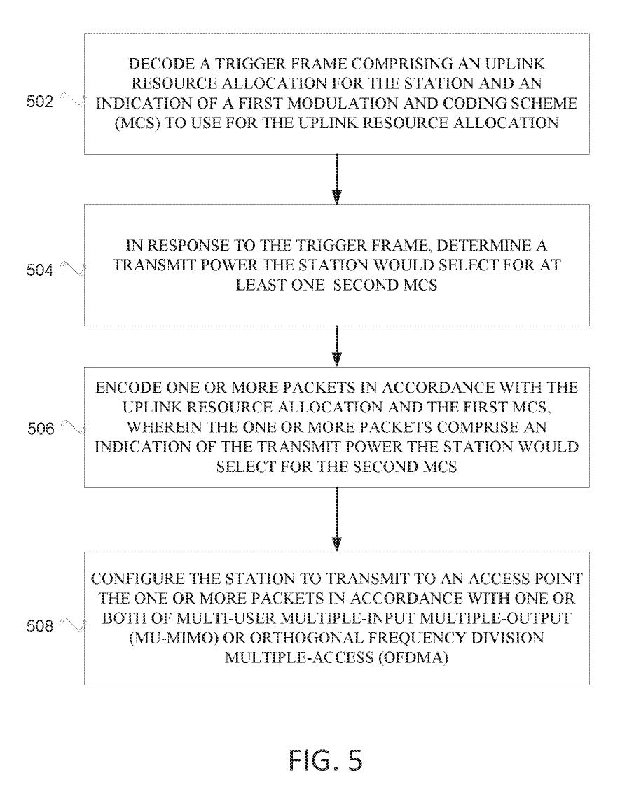

FIG. 5 illustrates a method 500 for controlling uplink transmit power in a WLAN in accordance with some embodiments. The method 500 may begin with operation 502 with decoding a trigger frame comprising an uplink resource allocation for the station and an indication of a first modulation and coding scheme (MCS) to use for the uplink resource allocation. For example, HE stations 104 may decode TF 216 that includes resource allocation 222 and MCS 218.

The method 500 may continue at operation 504 with in response to the trigger frame, determining a transmit power the station would select for at least one second MCS. For example, the TXP selector 304 may determine a selected TXP 306 for one or more MCSs 302. The HE station 104 may determine which MCSs 302 to select a selected TXP 306 for based on one or more of the following a request in the TF 216 (e.g., TXP information request 220), a communication standard, or based on a configuration of the HE station 104.

The method 500 may continue at operation 506 with encoding one or more packets in accordance with the uplink resource allocation and the first MCS, wherein the one or more packets comprise an indication of the transmit power the station would select for the second MCS. For example, HE station 104 may encode UL data 224 with TXP information 226.

The method 500 may continue at operation 508 with configuring the station to transmit to an access point the one or more packets in accordance with one or both of multi-user multiple-input multiple-output (MU-MIMO) or orthogonal frequency division multiple-access (OFDMA). For example, an apparatus of the HE stations 104 may configure the HE station 104 to transmit UL data 224 using the TXP 212 and MCS 218. In some embodiments, the TF 216 may include a TXP for the HE station 104 to use to transmit the UL data 224. The method 500 may continue with additional operation or may end.

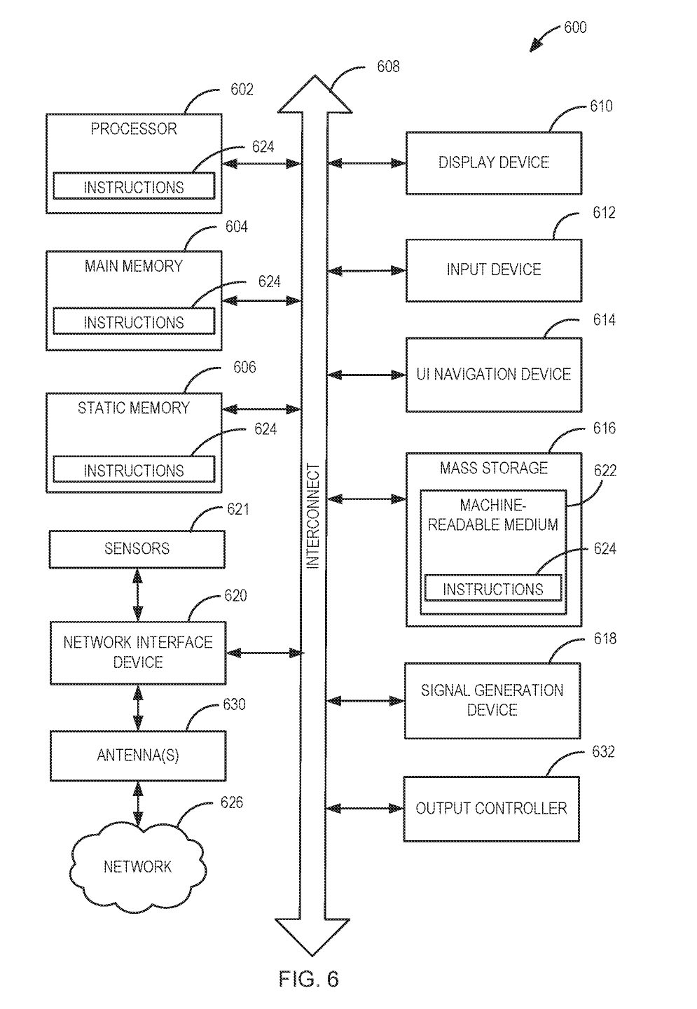

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a master station 102, HE station 104, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display.

The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry.

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media.

Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626.

In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

The following examples pertain to further embodiments. Example 1 is an apparatus of a wireless device including a memory; and processing circuitry couple to the memory, where the processing circuitry is configured to: determine first modulation and coding schemes (MCSs) to assign to each of one or more stations based on first reported transmission powers the one or more stations would select to transmit using second MCSs; encode a trigger frame including an uplink resource allocation for the one or more stations and an indication of the corresponding MCS of the MCSs for each of the one or more stations to use for the uplink resource allocation; configure the wireless device to transmit the trigger frame; and decode one or more packets from the corresponding one or more stations, where each packet is encoded with the corresponding MCS of the MCSs, and each packet comprises second reported transmission powers the corresponding station of the one or more stations would select for one or more probe MCSs, and where the one or more packets are to be received in accordance with one or both of orthogonal frequency division multiple-access (OFDMA) or multi-user multiple-input multiple-output (MU-MIMO).

In Example 2, the subject matter of Example 1 can optionally include where the processing circuitry is further configured to: determine the first MCSs to assign to each of one or more stations based on the reported selected transmission power the one or more stations would use to transmit using the corresponding first MCS of the first MCSs.

In Example 3, the subject matter of Examples 1 or 2 can optionally include where the one or more probe MCSs are based on one or more of the following: the first MCSs for each of the one or more stations to use for the uplink resource allocation, the second MCSs, and predetermined MCSs.

In Example 4, the subject matter of any of Examples 1-3 can optionally include where the processing circuitry is further configured to: encode the trigger frame to comprise a transmit power information request for at least one of the stations of the one or more stations, where the transmit power information request comprises an indication of the one or more probe MCSs.

In Example 5, the subject matter of Example 4 can optionally include where the transmit power information request comprises one of the following group: a reported transmit power for the corresponding first MCS, a reported transmit power for +1 of the corresponding first MCS; a reported transmit power for −1 of the corresponding first MCS; an reported transmit power for +1 of the corresponding first MCS and −1 of the corresponding first MCS; a reported transmit power for an indicated MCS; a reported transmit power for +2, +1, −1, and −2 of the corresponding first MCS; a reported transmit power for +3, +2, +1, −1, −2, and −3 of the corresponding first MCS; reported transmit power for X higher of the corresponding first MCS; reported transmit power for X higher and lower of the corresponding first MCS; and, an reported transmit power for X lower of the corresponding first MCS.

In Example 6, the subject matter of Example 5 can optionally include where the estimated transmit power is one from the following group: a differential power from a reference power, a differential power from a predetermined target power for a selected MCS, a different power from a predetermined target power for a selected MCS with an instantaneous limitation, an absolute power, and an indication of the estimated transmit power.

In Example 7, the subject matter of any of Examples 1-6 can optionally include where the receive range of the wireless device is determined by a gain configuration of the wireless device.

In Example 8, the subject matter of any of Examples 1-7 can optionally include where the processing circuitry is further configured to: determine the first MCSs to assign to each of one or more stations further based on one or both of signal to noise ratios of signals received from the corresponding one or more stations or error vector magnitudes (EVMs) of received signals from the corresponding one or more stations.

In Example 9, the subject matter of any of Examples 1-8 can optionally include where the processing circuitry is further configured to: determine third MCSs to assign to each of the one or more stations based on second reported transmission powers the corresponding station of the one or more stations would select for the one or more probe MCSs.

In Example 10, the subject matter of any of Examples 1-9 can optionally include where the processing circuitry is further configured to: determine one or more third transmit powers to assign to each of the one or more stations based on second reported transmission powers the corresponding station of the one or more stations would select for the one or more probe MCSs; and encode a second trigger frame including the one or more third transmit powers for each of the one or more stations to use the corresponding third transmit power for a corresponding second uplink resource allocation.

In Example 11, the subject matter of any of Examples 1-10 can optionally include where the wireless device and each of the one or more stations are one or more from the following group: an Institute of Electrical and Electronic Engineers (IEEE) 802.11ax access point, an IEEE 802.11 station, an IEEE access point, a station acting as a group owner (GO), and an IEEE 802.11ax station.

In Example 12, the subject matter of any of Examples 1-11 can optionally include transceiver circuitry coupled to the memory.

In Example 13, the subject matter of Example 12 can optionally include one or more antennas coupled to the transceiver circuitry.

Example 14 is a non-transitory computer-readable storage medium that stores instructions for execution by one or more processors, the instructions to configure the one or more processors to cause a wireless device to: determine first modulation and coding schemes (MCSs) to assign to each of one or more stations based on first reported transmission powers the one or more stations would select to transmit using the corresponding second MCSs; encode a trigger frame including an uplink resource allocation for the one or more stations and an indication of the corresponding first MCS of the first MCSs for each of the one or more stations to use for the uplink resource allocation; configure the wireless device to transmit the trigger frame; and decode one or more packets from the corresponding one or more stations, where each packet is encoded with the corresponding MCS of the MCSs, and each packet comprises second reported transmission powers the corresponding station of the one or more stations would select for one or more probe MCSs, and where the one or more packets are to be received in accordance with one or both of orthogonal frequency division multiple-access (OFDMA) or multi-user multiple-input multiple-output (MU-MIMO).

In Example 15, the subject matter of Examples 14 can optionally include where the transmit power information request comprises one of the following group: a reported transmit power for the corresponding first MCS, a reported transmit power for +1 of the corresponding first MCS; a reported transmit power for −1 of the corresponding first MCS; an reported transmit power for +1 of the corresponding first MCS and −1 of the corresponding first MCS; a reported transmit power for an indicated MCS; a reported transmit power for +2, +1, −1, and −2 of the corresponding first MCS; a reported transmit power for +3, +2, +1, −1, −2, and −3 of the corresponding first MCS; reported transmit power for X higher of the corresponding first MCS; reported transmit power for X higher and lower of the corresponding first MCS; and, an reported transmit power for X lower of the corresponding first MCS.

In Example 16, the subject matter of Example 15 can optionally include where the estimated transmit power is one from the following group: a differential power from a reference power, a differential power from a predetermined target power for a selected MCS, a different power from a predetermined target power for a selected MCS with an instantaneous limitation, an absolute power, and an indication of the estimated transmit power.

In Example 17, the subject matter of Examples 15 can optionally include where the instructions further configure the one or more processors to cause a wireless device to: determine the first MCSs to assign to each of one or more stations based on the reported selected transmission power the one or more stations would use to transmit using the corresponding first MCS of the first MCSs and further based on a receive range of the wireless device.

Example 18 is a method performed by an apparatus of a wireless device, the method including: determining first modulation and coding schemes (MCSs) to assign to each of one or more stations based on first reported transmission powers the one or more stations would select to transmit using second MCSs; encoding a trigger frame including an uplink resource allocation for the one or more stations and an indication of the corresponding first MCS of the first MCSs for each of the one or more stations to use for the uplink resource allocation; configuring the wireless device to transmit the trigger frame; and decoding one or more packets from the corresponding one or more stations, where each packet is encoded with the corresponding first MCS of the first MCSs, and each packet comprises second reported transmission powers the corresponding station of the one or more stations would select for one or more probe MCSs, and where the one or more packets are to be received in accordance with one or both of orthogonal frequency division multiple-access (OFDMA) or multi-user multiple-input multiple-output (MU-MIMO).

In Example 19, the subject matter of Example 18 can optionally include where the transmit power information request comprises one of the following group: a reported transmit power for the corresponding first MCS, a reported transmit power for +1 of the corresponding first MCS; a reported transmit power for −1 of the corresponding first MCS; an reported transmit power for +1 of the corresponding first MCS and −1 of the corresponding first MCS; a reported transmit power for an indicated MCS; a reported transmit power for +2, +1, −1, and −2 of the corresponding first MCS; a reported transmit power for +3, +2, +1, −1, −2, and −3 of the corresponding first MCS; reported transmit power for X higher of the corresponding first MCS; reported transmit power for X higher and lower of the corresponding first MCS; and, an reported transmit power for X lower of the corresponding first MCS.

Example 20 is an apparatus of a station including a memory; and processing circuitry couple to the memory, where the processing circuitry is configured to: decode a trigger frame including an uplink resource allocation for the station and an indication of a first modulation and coding scheme (MCS) to use for the uplink resource allocation; in response to the trigger frame, determine a transmit power the station would select for at least one second MCS; encode one or more packets in accordance with the uplink resource allocation and the first MCS, where the one or more packets comprise an indication of the transmit power the station would select for the second MCS; and configure the station to transmit to an access point the one or more packets in accordance with one or both of multi-user multiple-input multiple-output (MU-MIMO) or orthogonal frequency division multiple-access (OFDMA).

In Example 21, the subject matter of Example 20 can optionally include where the trigger frame further comprises a transmit power information request.

In Example 22, the subject matter of Example 21 can optionally include where the transmit power information request comprises one of the following group: a reported transmit power for the corresponding MCS, a reported transmit power for +1 MCS; a reported transmit power for −1 MCS; an reported transmit power for +1 MCS and −1 MCS; an reported transmit power for an indicated MCS; a reported transmit power for +2, +1, −1, and −2 MCS; a reported transmit power for +3, +2, +1, −1, −2, and −3 MCS; reported transmit power for X higher MCS; reported transmit power for X higher and lower MCS; and, an reported transmit power for X lower MCS.

In Example 23, the subject matter of Example 21 can optionally include where the processing circuitry is further configured to: determine the transmit power the station would select for the second MCS based on one or more of the following: Institute of Electrical and. Electronic Engineering (IEEE) 802.11ax standard, a regulation for maximum transmit power, an error vector magnitude (EVM), a transmit power for a mask, a spectral density maximum power, a total maximum power, a power save configuration, a transmit power to lower interference with a coexistent communication protocol such as BlueTooth®, and instructions from a master station regarding power control.

In Example 24, the subject matter of any of Examples 20-23 can optionally include transceiver circuitry coupled to the memory.

In Example 25, the subject matter of Example 24 can optionally include one or more antennas coupled to the transceiver circuitry.

Example 26 is an apparatus of a wireless device including a memory, the apparatus including: means for determining first modulation and coding schemes (MCSs) to assign to each of one or more stations based on first reported transmission powers the one or more stations would select to transmit using second MCSs; means for encoding a trigger frame including an uplink resource allocation for the one or more stations and an indication of the corresponding MCS of the MCSs for each of the one or more stations to use for the uplink resource allocation; means for configuring the wireless device to transmit the trigger frame; and
means for decoding one or more packets from the corresponding one or more stations, where each packet is encoded with the corresponding MCS of the MCSs, and each packet comprises second reported transmission powers the corresponding station of the one or more stations would select for one or more probe MCSs, and where the one or more packets are to be received in accordance with one or both of orthogonal frequency division multiple-access (OFDMA) or multi-user multiple-input multiple-output (MU-MIMO).

In Example 27, the subject matter of Example 26 can optionally include means for determining the first MCSs to assign to each of one or more stations based on the reported selected transmission power the one or more stations would use to transmit using the corresponding first MCS of the first MCSs.

In Example 28, the subject matter of Examples 26 or 27 can optionally include where the one or more probe MCSs are based on one or more of the following: the first MCSs for each of the one or more stations to use for the uplink resource allocation, the second MCSs, and predetermined MCSs.

In Example 29, the subject matter of any of Examples 26-28 can optionally include means for encoding the trigger frame to comprise a transmit power information request for at least one of the stations of the one or more stations, where the transmit power information request comprises an indication of the one or more probe MCSs.

In Example 30, the subject matter of Example 4 can optionally include where the transmit power information request comprises one of the following group: a reported transmit power for the corresponding first MCS, a reported transmit power for +1 of the corresponding first MCS; a reported transmit power for −1 of the corresponding first MCS; an reported transmit power for +1 of the corresponding first MCS and −1 of the corresponding first MCS; a reported transmit power for an indicated MCS; a reported transmit power for +2, +1, −1, and −2 of the corresponding first MCS; a reported transmit power for +3, +2, +1, −1, −2, and −3 of the corresponding first MCS; reported transmit power for X higher of the corresponding first MCS; reported transmit power for X higher and lower of the corresponding first MCS; and, an reported transmit power for X lower of the corresponding first MCS.

In Example 31, the subject matter of Example 30 can optionally include where the estimated transmit power is one from the following group: a differential power from a reference power, a differential power from a predetermined target power for a selected MCS, a different power from a predetermined target power for a selected MCS with an instantaneous limitation, an absolute power, and an indication of the estimated transmit power.

In Example 32, the subject matter of any of Examples 26-31 can optionally include where the receive range of the wireless device is determined by a gain configuration of the wireless device.

In Example 33, the subject matter of any of Examples 26-32 can optionally include means for determining the first MCSs to assign to each of one or more stations further based on one or both of signal to noise ratios of signals received from the corresponding one or more stations or error vector magnitudes (EVMs) of received signals from the corresponding one or more stations.

In Example 34, the subject matter of any of Examples 26-33 can optionally include means for determining third MCSs to assign to each of the one or more stations based on second reported transmission powers the corresponding station of the one or more stations would select for the one or more probe MCSs.

In Example 35, the subject matter of any of Examples 26-34 can optionally include means for determining one or more third transmit powers to assign to each of the one or more stations based on second reported transmission powers the corresponding station of the one or more stations would select for the one or more probe MCSs; and means for encoding a second trigger frame including the one or more third transmit powers for each of the one or more stations to use the corresponding third transmit power for a corresponding second uplink resource allocation.

In Example 36, the subject matter of any of Examples 26-35 can optionally include where the wireless device and each of the one or more stations are one or more from the following group: an Institute of Electrical and Electronic Engineers (IEEE) 802.11ax access point, an IEEE 802.11 station, an IEEE access point, a station acting as a group owner (GO), and an IEEE 802.11ax station.

In Example 37, the subject matter of any of Examples 26-36 can optionally include means for processing electromagnetic waves.

In Example 38, the subject matter of Example 37 can optionally include means for transmitting and receiving electromagnetic waves.

In Example 39 is a non-transitory computer-readable storage medium that stores instructions for execution by one or more processors, the instructions to configure the one or more processors to cause a station to: decode a trigger frame including an uplink resource allocation for the station and an indication of a first modulation and coding scheme (MCS) to use for the uplink resource allocation; in response to the trigger frame, determine a transmit power the station would select for at least one second MCS; encode one or more packets in accordance with the uplink resource allocation and the first MCS, where the one or more packets comprise an indication of the transmit power the station would select for the second MCS; and configure the station to transmit to an access point the one or more packets in accordance with one or both of multi-user multiple-input multiple-output (MU-MIMO) or orthogonal frequency division multiple-access (OFDMA).

In Example 40, the subject matter of Example 39 can optionally include where the trigger frame further comprises a transmit power information request.

In Example 41, the subject matter of Examples 39 can optionally include where the transmit power information request comprises one of the following group: a reported transmit power for the corresponding MCS, a reported transmit power for +1 MCS; a reported transmit power for −1 MCS; an reported transmit power for +1 MCS and −1 MCS; an reported transmit power for an indicated MCS; a reported transmit power for +2, +1, −1, and −2 MCS; a reported transmit power for +3, +2, +1, −1, −2, and −3 MCS; reported transmit power for X higher MCS; reported transmit power for X higher and lower MCS; and, an reported transmit power for X lower MCS.

In Example 42, the subject matter of Example 39 can optionally include where the instructions further configure the one or more processors to cause the station to: determine the transmit power the station would select for the second MCS based on one or more of the following: Institute of Electrical and Electronic Engineering (IEEE) 802.11ax standard, a regulation for maximum transmit power, an error vector magnitude (EVM), a transmit power for a mask, a spectral density maximum power, a total maximum power, a power save configuration, a transmit power to lower interference with a coexistent communication protocol such as BlueTooth®, and instructions from a master station regarding power control.

Example 43 is a method performed by an apparatus of a station, the method including: decoding a trigger frame including an uplink resource allocation for the station and an indication of a first modulation and coding scheme (MCS) to use for the uplink resource allocation; in response to the trigger frame, determining a transmit power the station would select for at least one second MCS; encoding one or more packets in accordance with the uplink resource allocation and the first MCS, where the one or more packets comprise an indication of the transmit power the station would select for the second MCS; and configuring the station to transmit to an access point the one or more packets in accordance with one or both of multi-user multiple-input multiple-output (MU-MIMO) or orthogonal frequency division multiple-access (OFDMA).

In Example 44, the subject matter of Example 43 can optionally include where the trigger frame further comprises a transmit power information request.

In Example 45, the subject matter of Example 43 can optionally include where the transmit power information request comprises one of the following group: a reported transmit power for the corresponding MCS, a reported transmit power for +1 MCS; a reported transmit power for −1 MCS; an reported transmit power for +1 MCS and −1 MCS; an reported transmit power for an indicated MCS; a reported transmit power for +2, +1, −1, and −2 MCS; a reported transmit power for +3, +2, +1, −1, −2, and −3 MCS; reported transmit power for X higher MCS; reported transmit power for X higher and lower MCS; and, an reported transmit power for X lower MCS.

In Example 46, the subject matter of Example 43 can optionally include determining the transmit power the station would select for the second MCS based on one or more of the following: institute of Electrical and Electronic Engineering (IEEE) 802.11ax standard, a regulation for maximum transmit power, an error vector magnitude (EVM), a transmit power for a mask, a spectral density maximum power, a total maximum power, a power save configuration, a transmit power to lower interference with a coexistent communication protocol such as BlueTooth®, and instructions from a master station regarding power control.

Example 47 is an apparatus of a station, the apparatus including: means for decoding a trigger frame including an uplink resource allocation for the station and an indication of a first modulation and coding scheme (MCS) to use for the uplink resource allocation; in response to the trigger frame, means for determining a transmit power the station would select for at least one second MCS; means for encoding one or more packets in accordance with the uplink resource allocation and the first MCS, where the one or more packets comprise an indication of the transmit power the station would select for the second MCS; and means for configuring the station to transmit to an access point the one or more packets in accordance with one or both of multi-user multiple-input multiple-output (MU-MIMO) or orthogonal frequency division multiple-access (OFDMA).

In Example 48, the subject matter of Example 47 can optionally include where the trigger frame further comprises a transmit power information request.

In Example 49, the subject matter of Example 47 can optionally include where the transmit power information request comprises one of the following group: a reported transmit power for the corresponding MCS, a reported transmit power for +1 MCS; a reported transmit power for −1 MCS; an reported transmit power for +1 MCS and −1 MCS; an reported transmit power for an indicated MCS; a reported transmit power for +2, +1, −1, and −2 MCS; a reported transmit power for +3, +2, +1, −1, −2, and −3 MCS; reported transmit power for X higher MCS; reported transmit power for X higher and lower MCS; and, an reported transmit power for X lower MCS.

In Example 50, the subject matter of Example 47 can optionally include means for determining the transmit power the station would select for the second MCS based on one or more of the following: Institute of Electrical and Electronic Engineering (IEEE) 802.11ax standard, a regulation for maximum transmit power, an error vector magnitude (EVM), a transmit power for a mask, a spectral density maximum power, a total maximum power, a power save configuration, a transmit power to lower interference with a coexistent communication protocol such as BlueTooth®, and instructions from a master station regarding power control.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a wireless device comprising: a memory; and processing circuitry couple to the memory, wherein the processing circuitry is configured to:
determine first modulation and coding schemes (MCSs) to assign to each of one or more stations based on first reported transmission powers the one or more stations would select to transmit using second MCSs;
encode a trigger frame comprising an uplink resource allocation for the one or more stations and an indication of the corresponding MCS of the MCSs for each of the one or more stations to use for the uplink resource allocation;
configure the wireless device to transmit the trigger frame; and
decode one or more packets from the corresponding one or more stations, wherein each packet is encoded with the corresponding MCS of the MCSs, and each packet comprises second reported transmission powers the corresponding station of the one or more stations would select for one or more probe MCSs, and wherein the one or more packets are to be received in accordance with one or both of orthogonal frequency division multiple-access (OFDMA) or multi-user multiple-input multiple-output (MU-MIMO).

2. The apparatus of claim 1, wherein the processing circuitry is further configured to:
determine the first MCSs to assign to each of one or more stations based on the reported selected transmission power the one or more stations would use to transmit using the corresponding first MCS of the first MCSs.

3. The apparatus of claim 1, wherein the one or more probe MCSs are based on one or more of the following: the first MCSs for each of the one or more stations to use for the uplink resource allocation, the second MCSs, and predetermined MCSs.

4. The apparatus of claim 1, wherein the processing circuitry is further configured to:
encode the trigger frame to comprise a transmit power information request for at least one of the stations of the one or more stations, wherein the transmit power information request comprises an indication of the one or more probe MCSs.

5. The apparatus of claim 4, wherein the transmit power information request comprises one of the following group: a reported transmit power for the corresponding first MCS, a reported transmit power for +1 of the corresponding first MCS; a reported transmit power for −1 of the corresponding first MCS; an reported transmit power for +1 of the corresponding first MCS and −1 of the corresponding first MCS; a reported transmit power for an indicated MCS; a reported transmit power for +2, +1, −1, and −2 of the corresponding first MCS; a reported transmit power for +3, +2, +1, −1, −2, and −3 of the corresponding first MCS; reported transmit power for X higher of the corresponding first MCS; reported transmit power for X higher and lower of the corresponding first MCS; and, an reported transmit power for X lower of the corresponding first MCS.

6. The apparatus of claim 5, wherein the estimated transmit power is one from the following group: a differential power from a reference power, a differential power from a predetermined target power for a selected MCS, a different power from a predetermined target power for a selected MCS with an instantaneous limitation, an absolute power, and an indication of the estimated transmit power.

7. The apparatus of claim 1, wherein the receive range of the wireless device is determined by a gain configuration of the wireless device.

8. The apparatus of claim 1, wherein the processing circuitry is further configured to:
determine the first MCSs to assign to each of one or more stations further based on one or both of signal to noise ratios of signals received from the corresponding one or more stations or error vector magnitudes (EVMs) of received signals from the corresponding one or more stations.

9. The apparatus of claim 1, wherein the processing circuitry is further configured to:
determine third MCSs to assign to each of the one or more stations based on second reported transmission powers the corresponding station of the one or more stations would select for the one or more probe MCSs.

10. The apparatus of claim 1, wherein the processing circuitry is further configured to:
determine one or more third transmit powers to assign to each of the one or more stations based on second reported transmission powers the corresponding station of the one or more stations would select for the one or more probe MCSs; and
encode a second trigger frame comprising the one or more third transmit powers for each of the one or more stations to use the corresponding third transmit power for a corresponding second uplink resource allocation.

11. The apparatus of claim 1, wherein the wireless device and each of the one or more stations are one or more from the following group: an Institute of Electrical and Electronic Engineers (IEEE) 802.11ax access point, an IEEE 802.11 station, an IEEE access point, a station acting as a group owner (GO), and an IEEE 802.11ax station.

12. The apparatus of claim 1, further comprising transceiver circuitry coupled to the memory.

13. The apparatus of claim 12, further comprising one or more antennas coupled to the transceiver circuitry.

14. A non-transitory computer-readable storage medium that stores instructions for execution by one or more processors, the instructions to configure the one or more processors to cause a wireless device to:
determine first modulation and coding schemes (MCSs) to assign to each of one or more stations based on first reported transmission powers the one or more stations would select to transmit using the corresponding second MCSs;
encode a trigger frame comprising an uplink resource allocation for the one or more stations and an indication of the corresponding first MCS of the first MCSs for each of the one or more stations to use for the uplink resource allocation;
configure the wireless device to transmit the trigger frame; and
decode one or more packets from the corresponding one or more stations, wherein each packet is encoded with the corresponding MCS of the MCSs, and each packet comprises second reported transmission powers the corresponding station of the one or more stations would select for one or more probe MCSs, and wherein the one or more packets are to be received in accordance with one or both of orthogonal frequency division multiple-access (OFDMA) or multi-user multiple-input multiple-output (MU-MIMO).

15. The non-transitory computer-readable storage medium of claim 14, wherein the transmit power information request comprises one of the following group: a reported transmit power for the corresponding first MCS, a reported transmit power for +1 of the corresponding first MCS; a reported transmit power for −1 of the corresponding first MCS; an reported transmit power for +1 of the corresponding first MCS and −1 of the corresponding first MCS; a reported transmit power for an indicated MCS; a reported transmit power for +2, +1, −1, and −2 of the corresponding first MCS; a reported transmit power for +3, +2, +1, −1, −2, and −3 of the corresponding first MCS; reported transmit power for X higher of the corresponding first MCS; reported transmit power for X higher and lower of the corresponding first MCS; and, an reported transmit power for X lower of the corresponding first MCS.

16. The non-transitory computer-readable storage medium of claim 15, wherein the estimated transmit power is one from the following group: a differential power from a reference power, a differential power from a predetermined target power for a selected MCS, a different power from a predetermined target power for a selected MCS with an instantaneous limitation, an absolute power, and an indication of the estimated transmit power.

17. The non-transitory computer-readable storage medium of claim 15, wherein the instructions further configure the one or more processors to cause the wireless device to:
determine the first MCSs to assign to each of one or more stations based on the reported selected transmission power the one or more stations would use to transmit using the corresponding first MCS of the first MCSs and further based on a receive range of the wireless device.

18. A method performed by an apparatus of a wireless device, the method comprising:
determining first modulation and coding schemes (MCSs) to assign to each of one or more stations based on first reported transmission powers the one or more stations would select to transmit using second MCSs;
encoding a trigger frame comprising an uplink resource allocation for the one or more stations and an indication of the corresponding first MCS of the first MCSs for each of the one or more stations to use for the uplink resource allocation;
configuring the wireless device to transmit the trigger frame; and
decoding one or more packets from the corresponding one or more stations, wherein each packet is encoded with the corresponding first MCS of the first MCSs, and each packet comprises second reported transmission powers the corresponding station of the one or more stations would select for one or more probe MCSs, and wherein the one or more packets are to be received in accordance with one or both of orthogonal frequency division multiple-access (OFDMA) or multi-user multiple-input multiple-output (MU-MIMO).

19. The method of claim 18, wherein the transmit power information request comprises one of the following group: a reported transmit power for the corresponding first MCS, a reported transmit power for +1 of the corresponding first MCS; a reported transmit power for −1 of the corresponding first MCS; an reported transmit power for +1 of the corresponding first MCS and −1 of the corresponding first MCS; a reported transmit power for an indicated MCS; a reported transmit power for +2, +1, −1, and −2 of the corresponding first MCS; a reported transmit power for +3, +2, +1, −1, −2, and −3 of the corresponding first MCS; reported transmit power for X higher of the corresponding first MCS; reported transmit power for X higher and lower of the corresponding first MCS; and, an reported transmit power for X lower of the corresponding first MCS.

20. An apparatus of a station comprising: a memory; and processing circuitry couple to the memory, wherein the processing circuitry is configured to:
decode a trigger frame comprising an uplink resource allocation for the station and an indication of a first modulation and coding scheme (MCS) to use for the uplink resource allocation;
in response to the trigger frame, determine a transmit power the station would select for at least one second MCS;
encode one or more packets in accordance with the uplink resource allocation and the first MCS, wherein the one or more packets comprise an indication of the transmit power the station would select for the second MCS; and
configure the station to transmit to an access point the one or more packets in accordance with one or both of multi-user multiple-input multiple-output (MU-MIMO) or orthogonal frequency division multiple-access (OFDMA).

21. The apparatus of claim 20, wherein the trigger frame further comprises a transmit power information request.

22. The apparatus of claim 21, wherein the transmit power information request comprises one of the following group: a reported transmit power for the corresponding MCS, a reported transmit power for +1 MCS; a reported transmit power for −1 MCS; an reported transmit power for +1 MCS and −1 MCS; an reported transmit power for an indicated MCS; a reported transmit power for +2, +1, −1, and −2 MCS; a reported transmit power for +3, +2, +1, −1, −2, and −3 MCS; reported transmit power for X higher MCS; reported transmit power for X higher and lower MCS; and, an reported transmit power for X lower MCS.

23. The apparatus of claim 21, wherein the processing circuitry is further configured to:
determine the transmit power the station would select for the second MCS based on one or more of the following: Institute of Electrical and Electronic Engineering (IEEE) 802.11ax standard, a regulation for maximum transmit power, an error vector magnitude (EVM), a transmit power for a mask, a spectral density maximum power, a total maximum power, a power save configuration, a transmit power to lower interference with a coexistent communication protocol such as BlueTooth®, and instructions from a master station regarding power control.

24. The apparatus of claim 20, further comprising transceiver circuitry coupled to the memory.

25. The apparatus of claim 20, further comprising one or more antennas coupled to the transceiver circuitry.
